(19) United States
(12) Patent Application Publication
(10) Pub. No.: US 2021/0079219 A1
(43) Pub. Date: Mar. 18, 2021

(54) MALEIMIDE RESIN COMPOSITION AND MALEIMIDE RESIN FILM

(71) Applicant: Shin-Etsu Chemical Co., Ltd., Tokyo (JP)

(72) Inventors: Hiroyuki IGUCHI, Annaka-shi (JP); Yoshihiro TSUTSUMI, Annaka-shi (JP); Yuki KUDO, Annaka-shi (JP); Atsushi TSUURA, Annaka-shi (JP)

(73) Assignee: Shin-Etsu Chemical Co., Ltd., Tokyo (JP)

(21) Appl. No.: 17/005,093

(22) Filed: Aug. 27, 2020

(30) Foreign Application Priority Data
Sep. 12, 2019 (JP) 2019-166245

(51) Int. Cl. C08L 79/08; C08L 27/18; C08K 5/14; C08K 5/49; C08K 5/101

(52) U.S. Cl. CPC C08L 79/085; C08L 27/18; C08L 2203/16; C08K 5/49; C08K 5/101; C08K 5/14

(57) ABSTRACT

Provided is a maleimide resin composition capable of being turned into a cured product superior in physical strength and dielectric property, having a fluororesin powder uniformly dispersed therein, exhibiting a low thixotropic ratio, and being turned into the shape of a film via coating. The maleimide resin composition contains:
(a) a maleimide represented by the following formula (1):

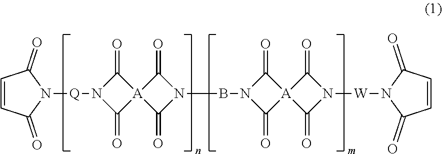

wherein independently represents a tetravalent organic group having a cyclic structure(s); B independently represents an alkylene group that has not less than 6 carbon atoms; Q independently represents an arylene group that has not less than 6 carbon atoms; W represents a group represented by B or Q; n represents a number of 0 to 100, m represents a number of 0 to 100, provided that at least one of n or m is a positive number;
(b) a fluororesin powder; and
(c) a curing catalyst.

### BACKGROUND OF THE INVENTION

### Field of the Invention

The present invention relates to a maleimide resin composition and a maleimide resin film.

### Background Art

In recent years, mobile communication devices as typified by mobile phones, base-station devices thereof, network infrastructure devices such as servers and routers, and electronic devices such as large-scale computers have seen a rapid increase in the speed of the signals used therein and an rapid increase in the capacities thereof year after year. In this regard, printed-wiring boards installed in these electronic devices are required to be compatible with higher frequencies such as those within a range of 20 to 90 GHz; a substrate material having a low relative permittivity and a low dielectric tangent is now demanded as such material is capable of reducing transmission loss. In addition to the electronic devices mentioned above, even in the field of ITS (automobiles, transportation system-related) and the field of indoor short-range communication, novel systems involving high-frequency wireless signals are now being put to practical use, or plans for putting them into practical use are being promoted; even the printed-wiring boards installed in these devices are now required to be made of a substrate material capable of reducing transmission loss.

Fluororesin substrates have low relative permittivities and dielectric tangents, and are thus used as substrates compatible with high frequencies. However, they are only used for limited purposes as they have downsides such as a difficulty in performing molding due to the thermoplastic characteristic thereof, and a low adhesion force to copper and/or a resist. Thus, there have been reported methods for filling an epoxy resin or a cyclic olefin resin with a fluororesin powder (JP-A-2019-035051, JP-A-2016-166347, JP-A-2013-079326, JP-A-2006-104318). However, a cured product will become brittle due to a poor compatibility between an epoxy resin or cyclic olefin resin and a fluororesin powder. Further, it is difficult to uniformly disperse a fluororesin powder in a composition containing an epoxy resin and cyclic olefin resin, which makes the composition unsuitable as a substrate material capable of reducing transmission loss. Furthermore, such composition has a significantly high thixotropy, and is difficult to be turned into the shape of a film via coating.

### SUMMARY OF THE INVENTION

In this way, it is an object of the preset invention to provide a maleimide resin composition capable of being turned into a cured product superior in physical strength and dielectric property, having a fluororesin powder uniformly dispersed therein, exhibiting a low thixotropic ratio, and being turned into the shape of a film via coating.

The inventors of the present invention diligently conducted a series of studies to solve the above problems, and completed the invention as follows. That is, the inventors found that the following maleimide resin composition could achieve the aforementioned objectives.

[1]
A maleimide resin composition comprising:

(a) a maleimide represented by the following formula (1):

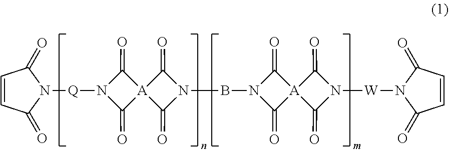

wherein A independently represents a tetravalent organic group having a cyclic structure(s); B independently represents an alkylene group that has not less than 6 carbon atoms, and may contain a hetero atom; Q independently represents an arylene group that has not less than 6 carbon atoms, and may contain a hetero atom; W represents a group represented by B or Q; n represents a number of 0 to 100, m represents a number of 0 to 100, provided that at least one of n or m is a positive number;

(b) a fluororesin powder; and

(c) a curing catalyst.

[2]
The maleimide resin composition according to [1], wherein the organic group represented by A in the formula (1) is any one of the tetravalent organic groups represented by the following structural formulae:

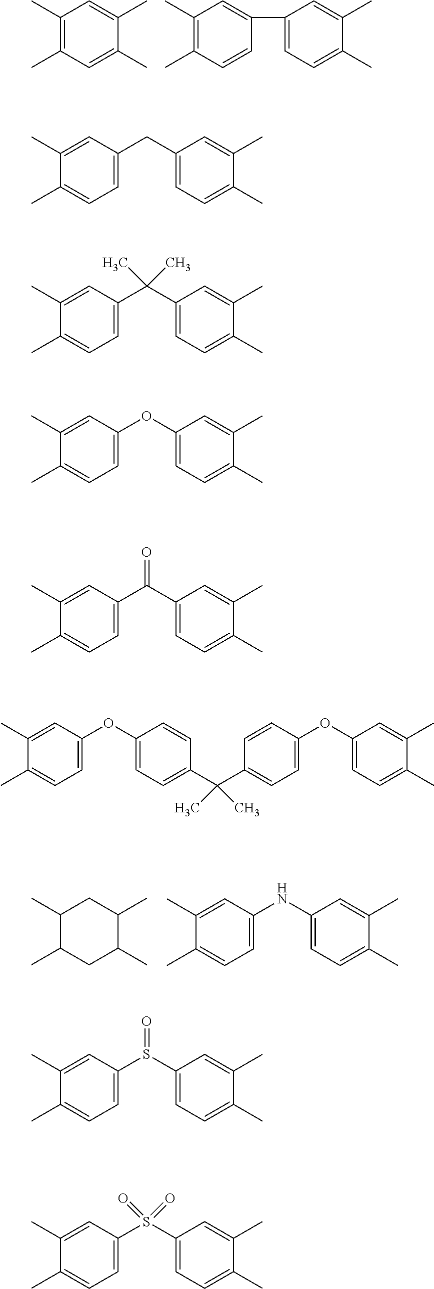

wherein bonds in the above structural formulae that are yet unbonded to substituent groups are to be bonded to carbonyl carbons forming cyclic imide structures in the formula (1).
[3]
The maleimide resin composition according to [1] or [2], wherein the fluororesin powder as the component (b) comprises at least one powder selected from polytetrafluoroethylene, polyvinylidene fluoride, polychlorotrifluoroethylene, tetrafluoroethylene-perfluoroalkyl vinyl ether copolymer, tetrafluoroethylene-hexafluoropropylene copolymer, polyvinyl fluoride, tetrafluoroethylene-hexafluoropropylene copolymer and ethylene-tetrafluoroethylene copolymer.
[4]
The maleimide resin composition according to any one of [1] to [3] further comprising, as a component (d), a (meth)acrylate having not less than 10 carbon atoms.
[5]
A cured product of the maleimide resin composition according to any one of [1] to [4].
[6]
A maleimide resin film comprised of the maleimide resin composition according to any one of [1] to [4].

The maleimide resin composition of the present invention has the fluororesin powder being uniformly dispersed therein, has a low thixotropic ratio, and is capable of being turned into the shape of a film via coating; the cured product of this composition is superior in physical strength and dielectric property. Thus, the maleimide resin composition of the present invention is suitable as a film material (particularly for use in a printed-wiring board).

### DETAILED DESCRIPTION OF THE INVENTION

The present invention is described in detail hereunder.

### (a) Maleimide Compound

A maleimide compound as a component (a) is a main component of the maleimide resin composition of the present invention, and is a maleimide compound represented by the following formula (1).

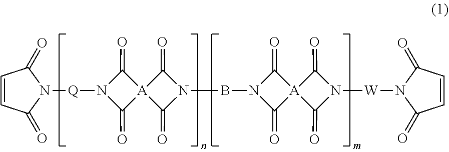

In the formula (1), A independently represents a tetravalent organic group having a cyclic structure(s); B independently represents an alkylene group that has not less than 6 carbon atoms, and may contain a hetero atom; Q independently represents an arylene group that has not less than 6 carbon atoms, and may contain a hetero atom; W represents a group represented by B or Q; n represents a number of 0 to 100, m represents a number of 0 to 100, provided that at least one of n or m is a positive number.

Here, the organic group expressed by A in the formula (1) independently represents a tetravalent organic group having a cyclic structure, and is preferably any one of the tetravalent organic groups represented by the following structural formulae:

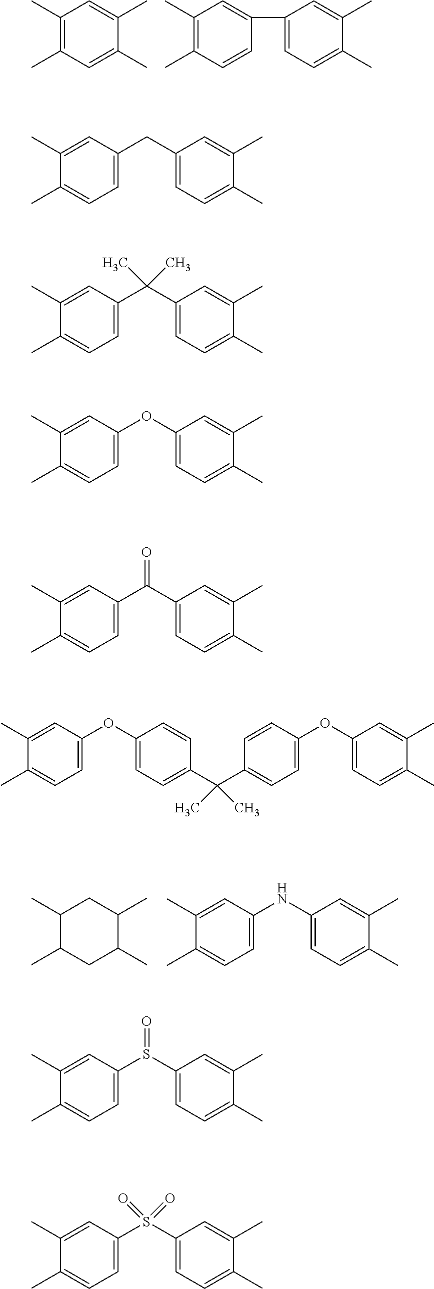

wherein bonds in the above structural formulae that are yet unbonded to substituent groups are to be bonded to carbonyl carbons forming cyclic imide structures in the formula (1).

Further, B in the formula (1) independently represents an alkylene group that has 6 to 60 carbon atoms and may contain a hetero atom, preferably an alkylene group that has 8 to 40 carbon atoms. B in the formula (1) may, for example, be a linear alkylene group having 6 to 60 carbon atoms, a branched alkylene group having 6 to 60 carbon atoms, or an aliphatic ring-containing alkylene group having 6 to 60 carbon atoms. As the linear alkylene group represented by B in the formula (1), an alkylene group having 6 to 60 carbon atoms is preferred, and an alkylene group having 8 to 40 carbon atoms is more preferred; specific examples thereof include —(CH₂)₆—, —(CH₂)₇—, —(CH₂)₈—, —(CH₂)₉—, —(CH₂)₁₀—, —(CH₂)₁₁—, —(CH₂)₁₂— and —(CH₂)₁₈—. It is even more preferred that B in the formula (1) represent any one of the aliphatic ring-containing alkylene groups expressed by the following structural formulae:

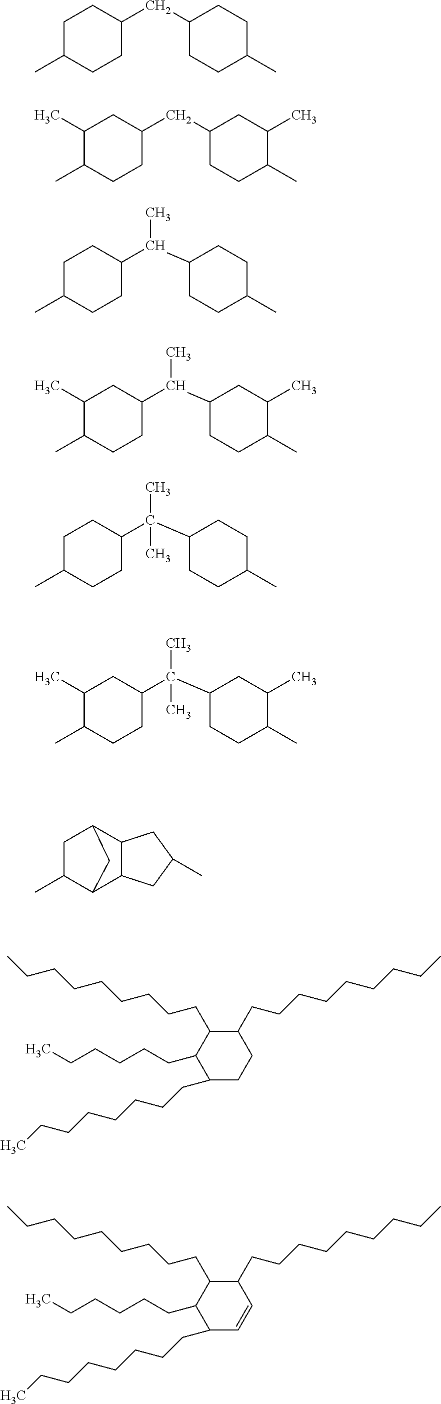

Bonds in the above structural formulae that are yet unbonded to substituent groups are to be bonded to nitrogen atoms forming cyclic imide structures in the formula (1).

Q independently represents an arylene group that has 6 to 30, preferably 8 to 18 carbon atoms, and may contain a hetero atom. It is more preferred that Q in the formula (1) be any one of the aromatic ring-containing arylene groups represented by the following structural formulae:

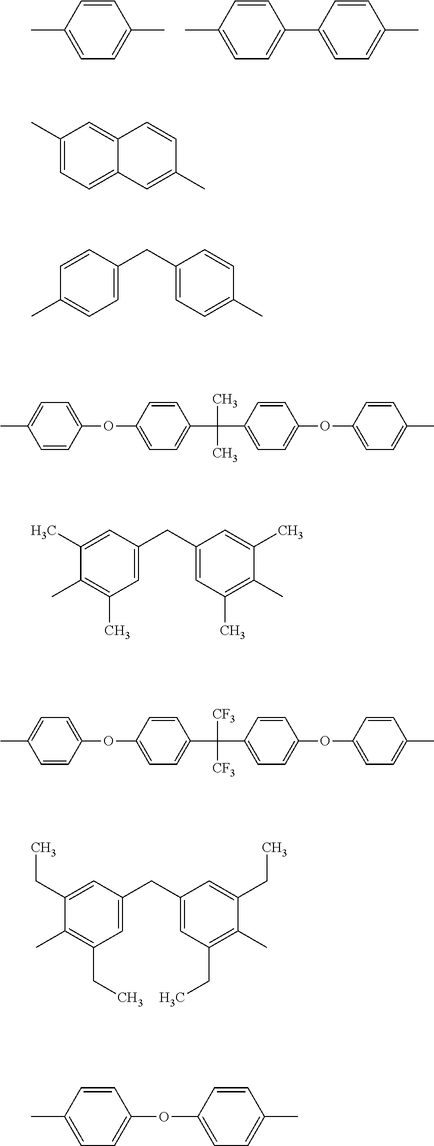

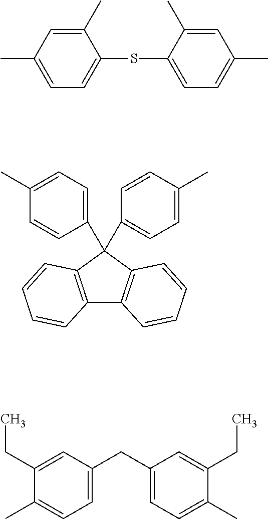

Bonds in the above structural formulae that are yet unbonded to substituent groups are to be bonded to nitrogen atoms forming cyclic imide structures in the formula (1).

In the formula (1), n represents a number of 0 to 100, preferably a number of 0 to 70. In the formula (1), m represents a number of 0 to 100, preferably a number of 0 to 70. Further, at least one of n or m represents a positive number.

While there are no particular restrictions on the weight-average molecular weight of the above maleimide compound, it is preferred that the weight-average molecular weight thereof be 500 to 50,000, more preferably 700 to 30,000, even more preferably 1,000 to 20,000. When the weight-average molecular weight of the maleimide compound is within these ranges, the maleimide resin composition of the invention will not exhibit an excessively high viscosity, and a cured product of such resin composition will have a high strength.

Here, the term “weight-average molecular weight” referred to in this specification is a weight-average molecular weight measured by GPC under the following conditions, using polystyrene as a reference substance.

Measurement condition
Developing solvent: tetrahydrofuran
Flow rate: 0.35 mL/min

### Detector: RI

Column: TSK-GEL Super HZ type (by TOSOH CORPORATION)
Super HZ4000 (4.6 mm I.D.×15 cm×1)
Super HZ3000 (4.6 mm I.D.×15 cm×1)
Super HZ2000 (4.6 mm I.D.×15 cm×1)
Column temperature: 40° C.
Sample injection volume: 5 μL (THF solution having concentration of 0.1% by weight)

As the maleimide compound, it may be synthesized by a common procedure from diamine and an acid anhydride, or a commercially available product may be used. Examples of such commercially available product include BMI-1400, BMI-1500, BMI-2500, BMI-2560, BMI-3000, BMI-5000, BMI-6000 and BMI-6100 (all by Designer Molecules Inc.). Further, one kind of maleimide compound may be used alone, or two or more kinds thereof may be used in combination.

It is preferred that the maleimide compound as the component (a) be contained in the composition of the present invention by an amount of 10 to 80% by mass, more preferably 20 to 70% by mass.

### (b) Fluororesin Powder

A fluororesin powder as a component (b) is a component for favorably lowering the relative permittivity and dielectric tangent of the cured product of the maleimide resin composition of the present invention (e.g. resin film). While there are no particular restrictions on the fluororesin powder, it is preferred that the fluororesin powder be at least one selected from polytetrafluoroethylene, polyvinylidene fluoride, polychlorotrifluoroethylene, tetrafluoroethylene-perfluoroalkyl vinyl ether copolymer, tetrafluoroethylene-hexafluoropropylene copolymer, polyvinyl fluoride, tetrafluoroethylene-hexafluoropropylene copolymer and ethylene-tetrafluoroethylene copolymer; more preferably at least one selected from polytetrafluoroethylene, tetrafluoroethylene-perfluoroalkyl vinyl ether copolymer, tetrafluoroethylene-hexafluoropropylene copolymer and tetrafluoroethylene-hexafluoropropylene copolymer. Any one kind of these fluororesin powders may be used alone, or two or more kinds thereof may be used in combination.

There are no particular restrictions on the shape of the fluororesin powder. The fluororesin powder may have, for example, a spherical shape, a scale-like shape, a flake-like shape, a stick-like shape, a crushed shape and an oval shape. Among these shapes, preferred are a spherical shape, a scale-like shape, a stick-like shape and a crushed shape; particularly preferred are a spherical shape, a scale-like shape and a crushed shape.

While there are no particular restrictions on the average particle size of the fluororesin powder, it is preferred that the average particle size thereof be 0.1 to 100 μm, more preferably 0.25 to 75 μm, even more preferably 0.5 to 50 μm, in terms of a median diameter measured by a laser diffraction-type particle size distribution measuring device. It is preferable when the average particle size of the fluororesin powder is within these ranges, because the fluororesin powder can then be easily dispersed in the maleimide resin composition in a uniform manner, and will not settle, separate and/or be unevenly distributed with time. Here, in a laser diffraction-type particle size distribution measuring device, particles exhibiting a pattern of a diffracted light that is identical to that of spherical particles having a diameter of 1 μm are deemed to have a diameter of 1 μm regardless of the shape of the particles. Further, if producing a later-described maleimide resin film, it is preferred that the particle size of the fluororesin powder be 50% or less of the thickness of the film. When the particle size is 50% or less of the film thickness, the fluororesin powder can then be easily dispersed in the resin film in a uniform manner, and an even flatter film can also be easily obtained.

The fluororesin powder may be surface-treated in advance with any surface treatment agent. An affinity to the maleimide compound can be improved by performing surface treatment. The surface treatment agent may, for example, be a surfactant. While there are no particular restrictions on a surfactant, examples thereof include surfactants such as a non-ionic surfactant, an ampholytic surfactant, a cationic surfactant and an anionic surfactant. Particularly, preferred are non-ionic surfactants having fluorine-modified organic groups such as a perfluoroalkyl group and a perfluoropolyether group.

Examples of the non-ionic surfactant include perfluoroalkyl ethylene oxide adduct, perfluoroalkyl esters, perfluoroalkyl group-hydrophilic group-containing oligomer, perfluoroalkyl group-lipophilic group-containing oligomer, perfluoroalkyl group-containing oligomer, perfluoroalkyl group-lipophilic group-containing urethane, perfluoroalkyl oligomer, perfluoroalkylamine oxide and an ethylene oxide adduct of perfluoroalkyl group-containing silicone.

Examples of the ampholytic surfactant include perfluoroalkylamino sulfonic acid salts (perfluoroalkyl betaines).

Examples of the cationic surfactant include perfluoroalkyltrimethylammonium salts such as perfluoroalkyltrimethylammonium iodide.

Examples of the anionic surfactant include perfluoroalkyl sulfonates such as ammonium perfluoroalkyl sulfonate, potassium perfluoroalkyl sulfonate and sodium perfluoroalkyl sulfonate; perfluoroalkyl carboxylates such as ammonium perfluoroalkyl carboxylate, potassium perfluoroalkyl carboxylate and sodium perfluoroalkyl carboxylate; perfluoroalkyl naphthalenesulfonates; perfluoroalkyl benzenesulfonates; perfluoroalkyl diallylsulfonates; and perfluoroalkyl phosphate esters.

Any one kind of these surface treatment agents may be used alone, or two or more kinds thereof may be used in combination.

The fluororesin powder (b) is contained in the maleimide resin composition of the present invention by an amount of 5 to 90% by mass, preferably 10 to 80% by mass, more preferably 20 to 60% by mass. When the amount of the fluororesin powder (b) is within these ranges, relative permittivity and dielectric tangent can be effectively reduced while maintaining the strength of the cured product of the resin composition.

### (c) Curing Catalyst

A curing catalyst as a component (c) is a catalyst for curing the maleimide resin composition. While there are no particular restrictions on a curing catalyst, there may be used, for example, a thermal radical polymerization initiator, a thermal cationic polymerization initiator, a thermal anionic polymerization initiator and a photopolymerization initiator.

Examples of a thermal radical polymerization initiator include organic peroxides such as methyl ethyl ketone peroxide, methyl cyclohexanone peroxide, methyl acetoacetate peroxide, acetylacetone peroxide, 1,1-bis(t-butylperoxy)3,3,5-trimethylcyclohexane, 1,1-bis(t-hexylperoxy)cyclohexane, 1,1-bis(t-hexylperoxy)3,3,5-trimethylcyclohexane, 1,1-bis(t-butylperoxy)cyclohexane, 2,2-bis(4,4-di-t-butylperoxycyclohexyl)propane, 1,1-bis(t-butylperoxy)cyclododecane, n-butyl-4,4-bis(t-butylperoxy)valerate, 2,2-bis(t-butylperoxy)butane, 1,1-bis(t-butylperoxy)-2-methylcyclohexane, t-butyl hydroperoxide, p-menthane hydroperoxide, 1,1,3,3-tetramethylbutyl hydroperoxide, t-hexyl hydroperoxide, dicumyl peroxide, 2,5-dimethyl-2,5-bis(t-butylperoxy)hexane, α,α′-bis(t-butylperoxy)diisopropylbenzene, t-butylcumyl peroxide, di-t-butyl peroxide, 2,5-dimethyl-2,5-bis(t-butylperoxy)hexyne-3, isobutyryl peroxide, 3,5,5-trimethyl hexanoyl peroxide, octanoyl peroxide, lauroyl peroxide, cinnamic acid peroxide, m-toluoyl peroxide, benzoyl peroxide, diisopropyl peroxy dicarbonate, bis(4-t-butylcyclohexyl)peroxydicarbonate, di-3-methoxybutyl peroxy dicarbonate, di-2-ethylhexyl peroxydicarbonate, di-sec-butyl peroxydicarbonate, di(3-methyl-3-methoxybutyl)peroxydicarbonate, di(4-t-butylcyclohexyl)peroxydicarbonate, α,α′-bis(neodecanoylperoxy)diisopropylbenzene, cumyl peroxyneodecanoate, 1,1,3,3-tetramethylbutyl peroxyneodecanoate, 1-cyclohexyl-1-methylethyl peroxyneodecanoate, t-hexyl peroxyneodecanoate, t-butyl peroxyneodecanoate, t-hexyl peroxypivalate, t-butyl peroxypivalate, 2,5-dimethyl-2,5-bis(2-ethylhexanoylperoxy)hexane, 1,1,3,3-tetramethylbutylperoxy-2-ethylhexanoate, 1-cyclohexyl-1-methylethylperoxy-2-ethylhexanoate, t-hexylperoxy-2-ethylhexanoate, t-butylperoxy-2-ethylhexanoate, t-butyl peroxyisobutyrate, t-butyl peroxymaleic acid, t-butyl peroxylaurate, t-butylperoxy-3,5,5-trimethylhexanoate, t-butylperoxyisopropylmonocarbonate, t-butylperoxy-2-ethylhexyl monocarbonate, 2,5-dimethyl-2,5-bis(benzoylperoxy)hexane, t-butyl peroxyacetate, t-hexyl peroxybenzoate, t-butylperoxy-m-toluoylbenzoate, t-butyl peroxybenzoate, bis (t-butylperoxy)isophthalate, t-butylperoxyallyl monocarbonate and 3,3′,4,4′-tetra(t-butylperoxycarbonyl)benzophenone; azo compounds such as 2,2′-azobis(N-butyl-2-methylpropionamide), 2,2′-azobis(N-cyclohexyl-2-methylpropionamide), 2,2′-azobis [N-(2-methylpropyl)-2-methylpropionamide], 2,2′-azobis[N-(2-methylethyl)-2-methylpropionamide], 2,2′-azobis(N-hexyl-2-methylpropionamide), 2,2′-azobis(N-propyl-2-methylpropionamide), 2,2′-azobis(N-ethyl-2-methylpropionamide), 2,2′-azobis[2-methyl-N-(2-hydroxyethyl)propionamide], 2,2′-azobis[N-(2-propenyl)-2-methylpropionamide], 2,2′-azobis{2-methyl-N-[1,1-bis(hydroxymethyl)-2-hydroxyethyl]propionamide}, 2,2′-azobis[N-(2-propenyl)-2-methylpropionamide] and dimethyl-1,1′-azobis(1-cyclohexanecarboxylate). Here, preferred are dicumyl peroxide, di-t-butyl peroxide, isobutyryl peroxide, 2,2′-azobis(N-butyl-2-methylpropionamide) and 2,2′-azobis[N-(2-methylethyl)-2-methylpropionamide]; more preferred are dicumyl peroxide and di-t-butyl peroxide and isobutyryl peroxide.

Examples of a thermal cationic polymerization initiator include aromatic iodonium salts such as (4-methylphenyl)[4-(2-methylpropyl)phenyl]iodonium cation, (4-methylphenyl)(4-isopropylphenyl)iodonium cation, (4-methylphenyl)(4-isobutyl)iodonium cation, bis(4-tert-butyl)iodonium cation, bis(4-dodecylphenyl)iodonium cation and (2,4,6-trimethylphenyl)[4-(1-methylacetic acid ethyl ether)phenyl] iodonium cation; and aromatic sulfonium salts such as diphenyl[4-(phenylthio)phenyl]sulfonium cation, triphenylsulfonium cation and alkyl triphenylsulfonium cation. Here, preferred are (4-methylphenyl)[4-(2-methylpropyl)phenyl]iodonium cation, (4-methylphenyl)(4-isopropylphenyl)iodonium cation, triphenylsulfonium cation and alkyl triphenylsulfonium cation; more preferred are (4-methylphenyl)[4-(2-methylpropyl)phenyl]iodonium cation and (4-methylphenyl)(4-isopropylphenyl)iodonium cation.

Examples of a thermal anionic polymerization initiator include imidazoles such as 2-methylimidazole, 2-ethylimidazole, 2-phenylimidazole, 2-ethyl-4-methylimidazole, 2-undecylimidazole and 1-cyanoethyl-2-ethyl-4-methylimidazole; amines such as triethylamine, triethylenediamine, 2-(dimethylamino methyl)phenol, 1,8-diaza-bicyclo[5.4.0] undecene-7, tris(dimethylamino methyl)phenol and benzyldimethylamine; and phosphines such as triphenylphosphine, tributylphosphine and trioctylphosphine. Preferred are 2-methylimidazole, 2-ethyl-4-methylimidazole, triethylamine, triethylenediamine, 1,8-diaza-bicyclo[5.4.0]undecene-7, triphenylphosphine and tributylphosphine. More preferred are 2-ethyl-4-methylimidazole, 1,8-diaza-bicyclo[5.4.0] undecene-7 and triphenylphosphine.

Although there are no particular restrictions on a photopolymerization initiator, examples thereof may include benzoyl compounds (or phenyl ketone compounds) such as benzophenone, particularly benzoyl compounds (or phenyl ketone compounds) having a hydroxy group on a carbon atom at the α-position of a carbonyl group, such as 1-hydroxycyclohexyl phenyl ketone, 2-hydroxy-2-methyl-1-phenylpropan-1-one and 1-(4-isopropylphenyl)-2-hydroxy-2-methylpropan-1-one; α-alkylaminophenone compounds such as 2-methyl-1-(4-methylthiophenyl)-2-morpholinopropan-1-one, 2-benzyl-2-dimethylamino-1-(4-morpholinophenyl)-1-butanone and 2-dimethylamino-2-(4-methyl-benzyl)-1-(4-morpholin-4-yl-phenyl)-butan-1-one; acylphosphine oxide compounds such as 2,4,6-trimethylbenzoyldiphenylphosphine oxide, bisacylmonoorganophosphine oxide and bis(2,6-dimethoxybenzoyl)-2,4,4-trimethylpentylphosphine oxide; benzoin ether compounds such as isobutylbenzoin ether; ketal compounds such as acetophenone diethyl ketal; thioxanthone compounds; and acetophenone compounds.

Particularly, since the radiation generated from a UV-LED is of single wavelength, it is effective to use photopolymerization initiators such as α-alkylaminophenone compounds and acylphosphine oxide compounds that have peaks in a range of 340 to 400 nm in absorption spectra, if employing a UV-LED as a light source.

Any one of these components (c) may be used alone, or two or more of them may be used in combination. While there are no particular restrictions on the amount of the component (c), the component (c) is contained in the maleimide resin composition of the present invention by an amount of 0.01 to 10% by mass, preferably 0.05 to 8% by mass, more preferably 0.1 to 5% by mass. When the amount of the component (c) is within these ranges, the maleimide resin composition can be cured sufficiently.

If necessary, the following components may also be added to the maleimide resin composition of the present invention.

(d) (Meth)Acrylate Having not Less than 10 Carbon Atoms

A component (d) has a favorable compatibility with the fluororesin powder (b) as is the case with the maleimide compound as the component (a), and is capable of improving an adhesion force of the cured product of the maleimide resin composition of the present invention.

The component (d) is a (meth)acrylate having not less than 10, preferably not less than 12, more preferably 14 to 40 carbon atoms. When the number of the carbon atoms in the (meth)acrylate is not smaller than 10, there can be achieved an effect of, for example, improving the adhesion force of the cured product of the maleimide resin composition, and a flexibility of a resin film can also be improved when producing a resin film.

While there are no particular restrictions on the number of the (meth)acrylic groups in each molecule of the component (d), such number is 1 to 3, preferably 1 or 2. When the number of the (meth)acrylic groups in each molecule of the component (d) is 1 to 3, the resin film will only undergo a small degree of contraction at the time of curing, and the adhesion force will not deteriorate.

Specific examples of the component (d) include, but are not limited to those represented by the following structural formulae:

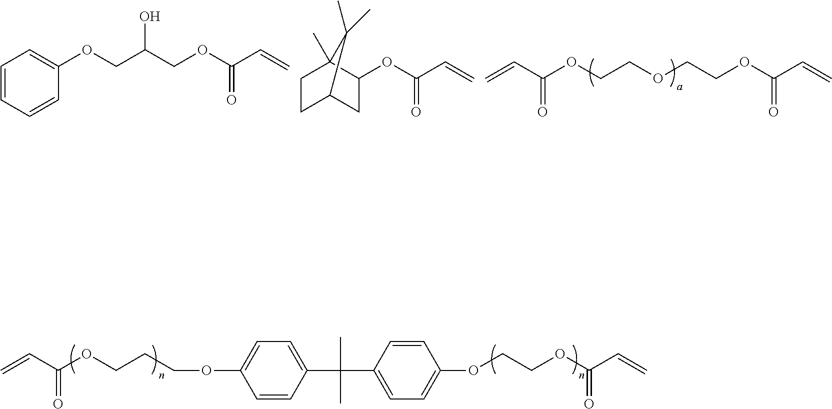

In the above formulae n is each within a range of 1 to 30.

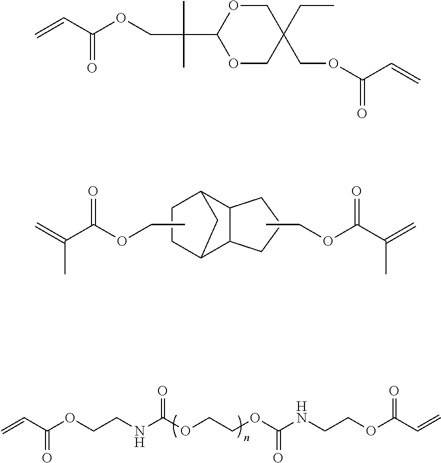

In the above formulae n is within a range of 1 to 30.

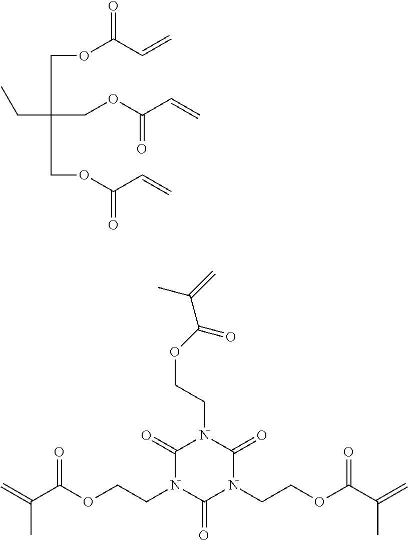 [SMILES: C=CC(=O)OCC(CC)(COC(=O)C=C)COC(=O)C=C ; C=C(C)C(=O)OCCn1c(=O)n(CCOC(=O)C(=C)C)c(=O)n(CCOC(=O)C(=C)C)c1=O]

While there are no particular restrictions on the amount of the component (d), the component (d) is added in an amount of 1 to 50% by mass, preferably 3 to 30% by mass, more preferably 5 to 20% by mass, with respect to the component (a). When the amount of the component (d) is within these ranges, a sufficient affinity to the fluororesin powder as the component (b) can be maintained, and the cured product of the resin composition will have a sufficient adhesion force.

Further, the maleimide resin composition of the present invention may also contain, for example, an adhesion aid, an antioxidant and a flame retardant, if necessary.

### Adhesion Aid

There are no particular restrictions on an adhesin aid. Examples of an adhesion aid include silane coupling agents such as n-propyltrimethoxysilane, n-propyltriethoxysilane, n-octyltrimethoxysilane, n-octyltriethoxysilane, phenyltrimethoxysilane, phenyltriethoxysilane, methyltrimethoxysilane, methyltriethoxysilane, 2-[methoxy(polyethyleneoxy)propyl]-trimethoxysilane, methoxytri(ethyleneoxy)propyltrimethoxysilane, 3-aminopropyltrimethoxysilane, 3-mercaptopropyltrimethoxysilane, 3-(methacryloyloxy)propyltrimethoxysilane, 3-isocyanatopropyltriethoxysilane, 3-isocyanatopropyltrimethoxysilane and glycidoxypropyltrimethoxysilane; and isocyanurate compounds such as triallyl isocyanurate and triglycidyl isocyanurate.

While there are no particular restrictions on the amount of such adhesion aid, it is preferred that the adhesion aid be contained in the maleimide resin composition by an amount of 0.1 to 10% by mass, more preferably 0.5 to 8% by mass, even more preferably 1 to 5% by mass. When the amount of the adhesion aid is within these ranges, the adhesion force of the cured product of the resin composition can be further improved without changing the properties of such resin composition.

### Antioxidant

There are no particular restrictions on an antioxidant. Examples of an antioxidant include phenolic antioxidants such as n-octadecyl-3-(3,5-di-t-butyl-4-hydroxyphenyl)propionate, n-octadecyl-3-(3,5-di-t-butyl-4-hydroxyphenyl)acetate, neododecyl-3-(3,5-di-t-butyl-4-hydroxyphenyl)propionate, dodecyl-β-(3,5-di-t-butyl-4-hydroxyphenyl)propionate, ethyl-α-(4-hydroxy-3,5-di-t-butylphenyl)isobutyrate, octadecyl-α-(4-hydroxy-3,5-di-t-butylphenyl)isobutyrate, octadecyl-α-(4-hydroxy-3,5-di-t-butyl-4-hydroxyphenyl)propionate, 2-(n-octylthio)ethyl-3,5-di-t-butyl-4-hydroxyphenyl acetate, 2-(n-octadecylthio)ethyl-3,5-di-t-butyl-4-hydroxyphenyl acetate, 2-(n-octadecylthio)ethyl-3-(3,5-di-t-butyl-4-hydroxyphenyl)propionate, 2-(2-stearoyloxyethylthio)ethyl-7-(3-methyl-5-t-butyl-4-hydroxyphenyl)heptanoate and 2-hydroxyethyl-7-(3-methyl-5-t-butyl-4-hydroxyphenyl)propionate; sulfuric antioxidants such as dilauryl-3,3′-thiodipropionate, dimyristyl-3,3′-thiodipropionate, distearyl-3,3′-thiodipropionate, ditridecyl-3,3′-thiodipropionate and pentaerythrityltetrakis(3-laurylthiopropionate); and phosphorus antioxidants such as tridecyl phosphite, triphenyl phosphite, tris(2,4-di-t-butylphenyl)phosphite, 2-ethylhexyldiphenyl phosphite, diphenyl tridecyl phosphite, 2,2-methylene bis(4,6-di-t-butylphenyl)octyl phosphite, distearyl pentaerythritol diphosphite, bis(2,6-di-t-butyl-4-methylphenyl)pentaerythritol diphosphite and 2-[[2,4,8,10-tetrakis(1,1-dimethylethyl)dibenzo[d,f][1,3,2]dioxaphosphepin-6-yl]oxy]-N,N-bis[2-[[2,4,8,10-tetrakis(1,1-dimethylethyl)dibenzo[d,f] [1,3,2]dioxaphosphepin-6-yl]oxy]-ethyl]ethanamine.

There are no particular restrictions on the amount of such antioxidant. It is preferred that the antioxidant be contained in the maleimide resin composition by an amount of 0.00001 to 5% by mass, more preferably 0.0001 to 4% by mass, even more preferably 0.001 to 3% by mass. When the amount of the antioxidant is within these ranges, the resin composition can be prevented from being oxidized, without changing the mechanical properties of such resin composition.

### Flame Retardant

There are not particular restrictions on a flame retardant; a phosphorus flame retardant, a metal hydrate and a halogenated flame retardant may, for example, be used. Examples of a phosphorus flame retardant include red phosphorus; ammonium phosphates such as monoammonium phosphate, diammonium phosphate, triammonium phosphate and ammonium polyphosphate; inorganic nitrogen-containing phosphorus compounds such as phosphoric amide; phosphoric acid; phosphine oxide; triphenyl phosphate; tricresyl phosphate; trixylenyl phosphate; cresyldiphenyl phosphate; cresyl di-2,6-xylenyl phosphate; resorcinol bis(diphenylphosphate); 1,3-phenylene bis(di-2,6-xylenylphosphate); bisphenol A-bis(diphenylphosphate); 1,3-phenylene bis (diphenylphosphate); divinyl phenylphosphonate; diallyl phenylphosphonate; bis(1-butenyl) phenylphosphonate; diphenylphosphinic acid phenyl; diphenylphosphinic acid methyl; phosphazene compounds such as bis(2-allylphenoxy)phosphazene and dicresyl phosphazene; melamine phosphate; melamine pyrophosphate; melamine polyphosphate; melam polyphosphate; 9,10-dihydro-9-oxa-10-phosphaphenanthrene-10-oxide; and 10-(2,5-dihydroxyphenyl)-9,10-dihydro-9-oxa-10-phosphaphenanthrene-10-oxide. Examples of a metal hydrate include aluminum hydroxide hydrate and magnesium hydroxide hydrate. Examples of a halogenated flame retardant include hexabromobenzene, pentabromotoluene, ethylenebis(pentabromophenyl), ethylenebistetrabromophthalimide, 1,2-dibromo-4-(1,2-dibromoethyl)cyclohexane, tetrabromocyclooctane, hexabromocyclododecane, bis(tribromophenoxy)ethane, brominated polyphenylene ether, brominated polystyrene and 2,4,6-tris(tribromophenoxy)-1,3,5-triazine.

While there are no particular restrictions on the amount of such flame retardant, it is preferred that the flame retardant be contained in the maleimide resin composition by an amount of 0.01 to 5% by mass, more preferably 0.05 to 4% by mass, even more preferably 0.1 to 3% by mass. When the amount of the flame retardant is within these ranges, a flame retardancy can be imparted to the resin composition without changing the mechanical properties of such resin composition.

### Production Method

As for a method for producing the maleimide resin composition of the present invention, there are no particular restrictions on, for example, an order in which the components (a), (b) and (c) as well as various optional components are added, and methods by which the composition of the invention is prepared. The given amounts of the components may be mixed at 20 to 100° C., preferably 25 to 80° C., in accordance with a normal method. If the dispersibility of the fluororesin powder as the component (b) is poor, the dispersibility may then be improved by using a triple roll mill, a ball mill or the like if necessary.

### Maleimide Resin Film

The maleimide resin composition of the present invention may be turned into the shape of a film via coating. There are no particular restrictions on a method for performing coating so as to turn the composition into the shape of a film. There may be employed a coating method where the resin composition may, for example, be spread onto a resin film or the like having a mold releasability to the composition, and then squeegeed using a squeegee.

At that time, it is preferred that the maleimide resin composition already have a lower viscosity after, for example, being heated or diluted with a solvent. When diluted with the organic solvent, it is preferable if a thixotropic ratio of the composition diluted is 1.0 to 3.0, because a favorable workability can be achieved; it is more preferred that this thixotropic ratio be 1.0 to 2.5, even more preferably 1.0 to 2.0. Here, the thixotropic ratio is calculated based on the following formula in a way such that the viscosity of the composition at 25° C. is at first measured with a rotary viscometer described in JIS K 7117-1:1999 at different revolutions of the spindle.

Thixotropic ratio=(viscosity at 1 rpm [Pa·s]/viscosity at 10 rpm [Pa·s])

There are no particular restrictions on such organic solvent, so long as the maleimide resin composition can be dissolved and uniformly dispersed therein. Specific examples of the organic solvent as the component (e) include toluene, xylene, methylethylketone, methylisobutylketone, cyclohexanone, cyclopentanone, anisole, diphenyl ether, propyl acetate and butyl acetate. Among these examples, preferred are cyclohexanone, cyclopentanone, anisole, butyl acetate and the like.

Further, a resin film having a mold releasability to the maleimide resin film of the present invention may also be placed on the maleimide resin film. The resin film having such mold releasability is optimized based on the kind of the maleimide resin. Specific examples of such resin film include a PET (polyethylene terephthalate) film coated with a fluorine-based resin; a PET film coated with a silicone resin; and fluorine-based resin films such as a PTFE (polytetrafluoroethylene) film, an ETFE (poly(ethylene-tetrafluoroethylene)) film and a CTFE (polychlorotrifluoroethylene) film. These resin films having the mold releasability improve a handling property of the maleimide resin film, and are capable of preventing foreign substances such as dust from adhering to the maleimide resin film.

It is preferred that the maleimide resin film of the present invention have a thickness of 1 to 2,000 μm, more preferably 1 to 500 μm, even more preferably 10 to 300 μm. When the thickness of the maleimide resin film is smaller than 1 μm, it will be difficult to attach it to a substrate or the like; when the thickness of the maleimide resin film is larger than 2,000 μm, the maleimide resin film will have a difficulty in maintaining a flexibility as a film. Further, it is preferred that the film thickness be twice the particle size of the fluororesin powder as the component (b) or larger, more preferably three times the particle size of such fluororesin powder or larger, even more preferably 5 to 1,000 times the particle size of such fluororesin powder. When the film thickness is within these ranges, concavities and convexities caused by the fluororesin powder are now less likely to occur on the film.

A method for using the maleimide resin film of the present invention may be as follows. That is, the resin film having the mold releasability is to be peeled off if such resin film is already placed on the maleimide resin film of the invention, followed by sandwiching the maleimide resin film between a substrate or the like and a semiconductor or the like, and then performing thermal compression bonding so as to cure the maleimide resin film. It is preferred that the maleimide resin film be heated at a temperature of 100 to 300° C. for 10 min to 4 hours, more preferably 120 to 250° C. for 20 min to 3 hours, even more preferably 150 to 200° C. for 30 min to 2 hours. It is preferred that a pressure for performing compression bonding be 0.01 to 100 MPa, more preferably 0.05 to 80 MPa, even more preferably 0.1 to 50 MPa.

### WORKING EXAMPLE

The present invention is described in greater detail hereunder with reference to synthetic, working and comparative examples. However, the present invention is not limited to the following working examples.

(a) Maleimide compound

(a-1) Bismaleimide Compound

1,12-Diaminododecane of 200 g (1.0 mol) and pyromellitic dianhydride of 207 g (0.95 mol) were added to N-methyl pyrrolidone of 196 g, followed by stirring them at 25° C. for three hours, and then stirring them at 150° C. for another three hours. Maleic anhydride of 196 g (2.0 mol), sodium acetate of 82 g (1.0 mol) and acetic anhydride of 204 g (2.0 mol) were then added to the solution thus obtained, followed by performing stirring at 80° C. for an hour. Later, toluene of 500 g was added to the reaction solution, followed by washing the solution with water, dewatering the solution washed, and then distilling away the solvent under a reduced pressure to obtain a bismaleimide compound (a-1) represented by the following formula (weight-average molecular weight 3,500).

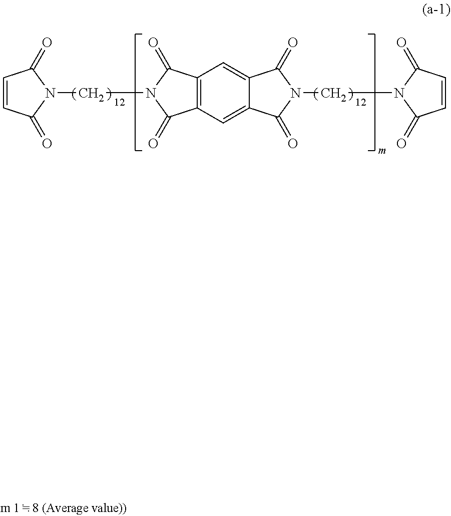

(a-2) Bismaleimide Compound

Maleimide compound represented by the following formula (BMI-2500 by Designer Molecules Inc.) (weight-average molecular weight 3,500)

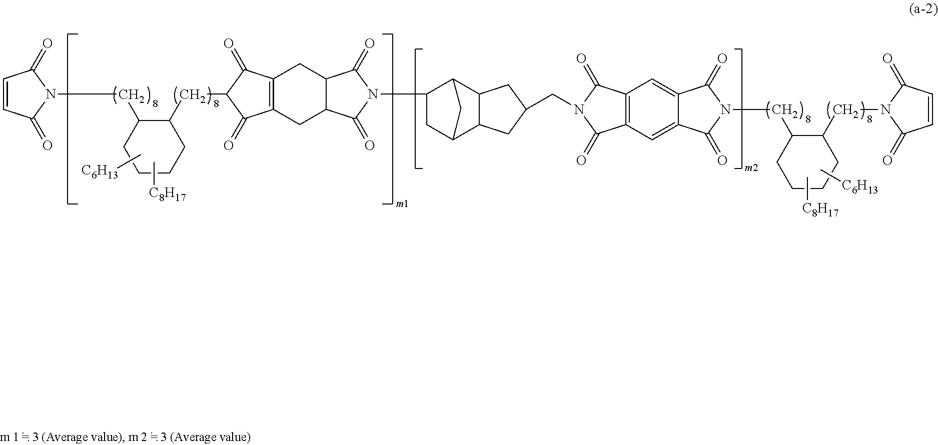

(a-3) Bismaleimide Compound

Maleimide compound represented by the following formula (BMI-1500 by Designer Molecules Inc.) (weight-average molecular weight 2,100)

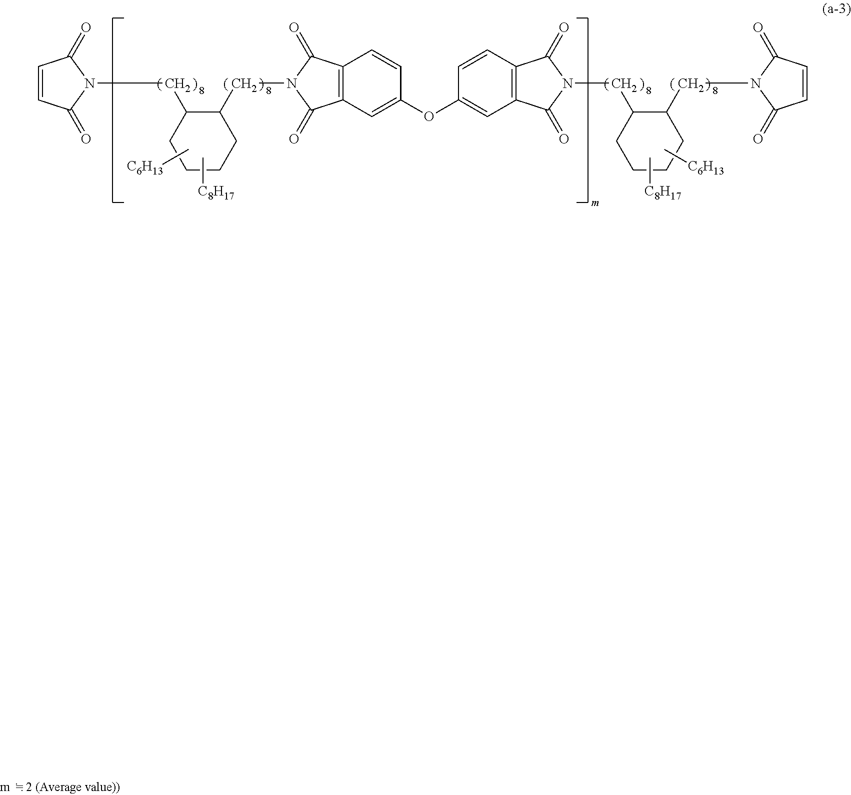

(a-4) Bismaleimide Compound

3,3′-Diethyl-4,4′-diaminodiphenylmethane (KAYAHARD AA by Nippon Kayaku Co., Ltd.) of 252 g (1.0 mol) and pyromellitic dianhydride of 207 g (0.9 mol) were added to N-methyl pyrrolidone of 350 g, followed by stirring them at room temperature for three hours, and then stirring them at 120° C. for another three hours. Maleic anhydride of 196 g (2.0 mol), sodium acetate of 82 g (1.0 mol) and acetic anhydride of 204 g (2.0 mol) were then added to the solution thus obtained, followed by performing stirring at 80° C. for an hour. Later, toluene of 500 g was added to the reaction solution, followed by washing the solution with water, dewatering the solution washed, and then distilling away the solvent under a reduced pressure to obtain a bismaleimide (a-4) represented by the following formula (weight-average molecular weight 1,800).

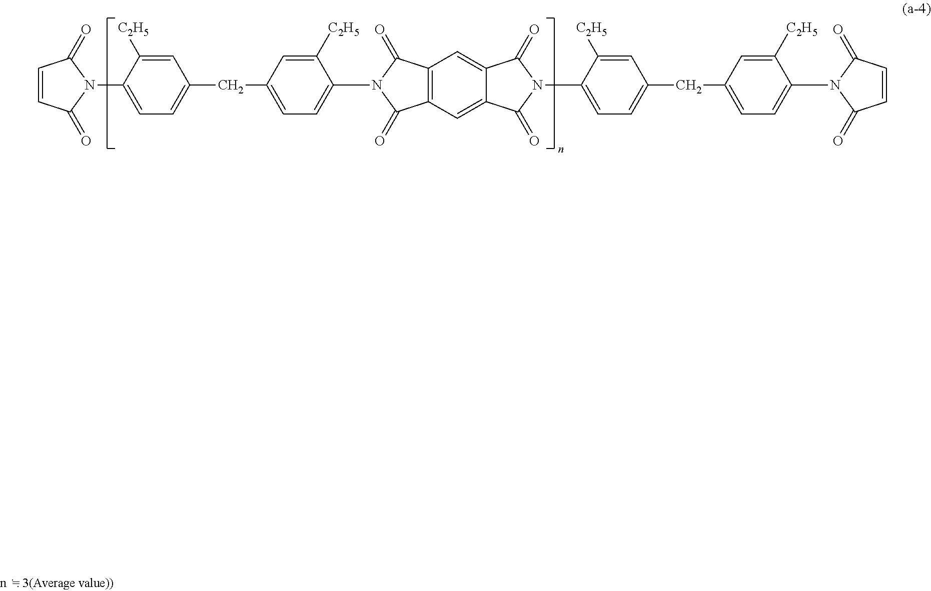

(a-5) Epoxy Resin (for Use in Comparative Examples)

jER-828EL (by Mitsubishi Chemical Corporation)

(a-6) Bismaleimide Compound

Maleimide compound represented by the following formula (BMI-3000 by Designer Molecules Inc.) (weight-average molecular weight 4,000)

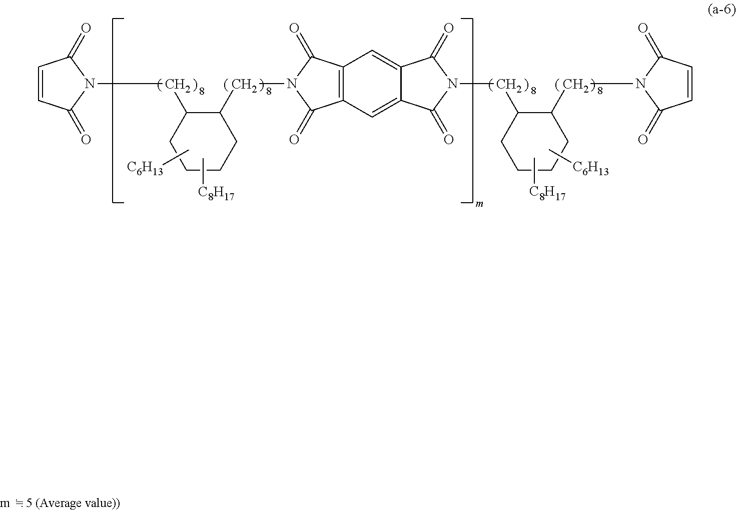

(a-7) Bismaleimide Compound (for Use in Comparative Examples)

Maleimide compound represented by the following formula (BMI-2300 by Daiwa Fine Chemicals Co., Ltd.) (weight-average molecular weight 400)

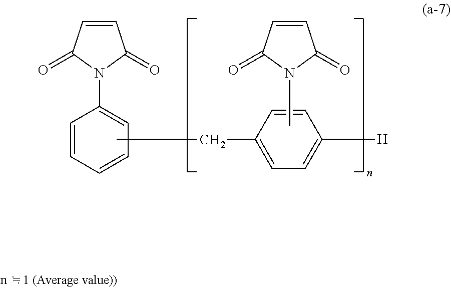

(a-8) Cyclic Olefin Resin (for Use in Comparative Examples)

Avatrel (by Promerus LLC, 1,3,5-trimethylbenzene solution, resin 20% by mass)

### (b) Fluororesin Powder

(b-1) Scale-shaped polytetrafluoroethylene filler (TFW-3000F by Seishin Enterprise Co., Ltd., average particle size 3 μm)

(b-2) Spherical polytetrafluoroethylene filler (KTL-500F by KITAMURA LIMITED, average particle size 600 nm)

(b-3) Crushed polytetrafluoroethylene filler (TF-9205 by 3M Japan, average particle size 8 m)

(b-4) Crushed polytetrafluoroethylene filler (LUBRON L-5 by Daikin Industries, Ltd., average particle size 5 μm)

### (c) Curing Catalyst

(c-1) Dicumylperoxide (PERCUMYL D by NOF CORPORATION)

(c-2) Triphenylphosphine (by Kishida Chemical Co., Ltd.)

(d) (Meth)Acrylate Having not Less than 10 Carbon Atoms

(d-1) Acrylate represented by the following formula (KAYARAD R-604 by Nippon Kayaku Co., Ltd.)

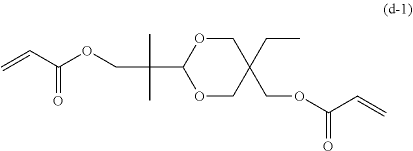 [SMILES: C=CC(=O)OCC1(CC)COC(C(C)(C)COC(=O)C=C)OC1]

(d-2) Isobornyl acrylate (by OSAKA ORGANIC CHEMICAL INDUSTRY LTD.)

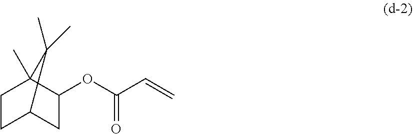

### Maleimide Resin Composition

In working examples 1 to 5; and comparative examples 1 to 4, maleimide resin compositions were produced by performing kneading at 80° C. using a hot twin-roll mill, where compounding ratios (parts by mass) shown in Table 1 were employed.

### Maleimide Resin Film

In working examples 6 to 9; and comparative examples 5 to 12, the components were dissolved and dispersed in cyclohexanone in accordance with the compounding ratios (parts by mass) shown in Table 2, followed by putting them into a stirrer THINKY CONDITIONING MIXER (by THINKY CORPORATION) to perform stirring and defoaming for 3 min so that a maleimide resin composition produced would have 60 to 77% by mass of a non-volatile content(s) and exhibit a viscosity of 1.5 to 2.0 Pa s when measured by a rotary viscometer described in JIS K 7117-1:1999 at 25° C. and 10 rpm. An automatic coating device PI-1210 (TESTER SANGYO CO., LTD) was then used to apply the maleimide resin composition to an ETFE (ethylene-tetrafluoroethylene) film, followed by molding them into the shape of a film having a size of length 150 mm×width 150 mm×thickness 50 μm. Later, heating was performed at 100° C. for 30 min to volatilize cyclohexanone, thus obtaining a resin film being a solid at 25° C. and having a size of length 150 mm×width 150 mm×thickness 30 μm.

### Tensile Strength and Elongation at Break

The maleimide resin composition produced was placed on a concave mold having a PTFE-coated surface and a size of 100 mm×100 mm×thickness 2 mm, and then subjected to hot press at 180° C. for two hours, thereby obtaining a test sample. A tabletop small-sized tester (EZ-L by Shimadzu Corporation) was used to measure a tensile strength and elongation at break of the test sample at a testing rate of 500 mm/min, an inter-gripper distance of 80 mm, and a gauge length of 40 mm. The results thereof are shown in Table 1.

Relative Permittivity and Dielectric Tangent

A mold frame having a size of 60 mm×60 mm and a thickness of 0.1 mm was used to sandwich the maleimide resin composition produced (working examples 1 to 5; comparative examples 1 to 4), followed by performing hot press at 180° C. for two hours, thereby obtaining a test sample. The test sample prepared was then connected to a network analyzer (E5063-2D5 by Keysight Technologies) and a stripline (by KEYCOM Corp.) to measure a relative permittivity and a dielectric tangent thereof at a frequency of 10 GHz. The results thereof are shown in Table 1.

Further, the maleimide resin film produced (working examples 6 to 9; comparative examples 5 to 12) was treated at 180° C. for two hours so as to be completely cured, followed by using a method similar to the above method to measure a relative permittivity and a dielectric tangent thereof at a frequency of 10 GHz. The results thereof are shown in Table 2.

### Adhesion Force

A spacer of 100 μm was placed on a 20 mm-squared silicon wafer, and the maleimide resin composition produced was then applied thereto so that the composition would have a thickness of 100 μm thereon, followed by pressing a 2 mm-squared silicon chip thereagainst from above, and then heating them at 180° C. for two hours so as to complete curing. Later, an adhesion force measurement device (universal bond tester, series 4000 (DS-100) by Nordson Corporation) was used to measure an adhesion force observed when flicking the chip sideways (die shear test). The results thereof are shown in Table 1.

### Thixotropic Ratio

As for the maleimide resin composition produced in accordance with the compounding ratios (parts by mass) shown in Table 2, a thixotropic ratio thereof before the composition was turned into the shape of a film via coating was calculated based on the following formula in a way such that the viscosity of the composition at 25° C. was at first measured with a rotary viscometer described in JIS K 7117-1:1999 at different revolutions of the spindle. The results are shown in Table 2.

Thixotropic ratio=(viscosity at 1 rpm [Pa·s]/viscosity at 10 rpm [Pa·s])

### Arithmetic Average Surface Roughness

A laser microscope (VKX-110 by KEYENCE CORPORATION) was used to measure an arithmetic average surface roughness (Ra) of the surface of the maleimide resin film produced, under the following measurement conditions. The results thereof are shown in Table 2.

Measurement condition
Object lens: 50 times magnification
Measurement mode: surface shape
Measurement quality: high precision (pitch 0.02 μm)

TABLE 1

| | | | Working | Working | Working | Working | Working | Comparative | Comparative | Comparative | Comparative |
|---|---|---|---|---|---|---|---|---|---|---|---|
| | | | example | example | example | example | example | example | example | example | example |
| | | | 1 | 2 | 3 | 4 | 5 | 1 | 2 | 3 | 4 |
| (a) | (a-1) | | 60 | | | | 10 | | | | |
| | (a-2) | | | 80 | | | | | | | |
| | (a-3) | | | | 40 | | | | | | |
| | (a-4) | | | | | 60 | | | | | |
| | (a-5) | | | | | | | 60 | 80 | 40 | 60 |
| (b) | (b-1) | | 39 | | | | | 39 | | | |
| | (b-2) | | | 19 | | | | | 19 | | |
| | (b-3) | | | | 49 | | 75 | | | 49 | |
| | (b-4) | | | | | 29 | | | | | 29 |
| (c) | (c-1) | | | | | | 1 | | | | |
| | (c-2) | | 1 | 1 | 1 | 1 | | 1 | 1 | 1 | 1 |
| (d) | (d-1) | | | | 10 | | | | | 10 | |
| | (d-2) | | | | | 10 | 14 | | | | 10 |
| Evaluation | Tensile | MPa | 8 | 15 | 12 | 13 | 7 | 4 | 5 | 5 | 5 |
| result | strength | | | | | | | | | | |
| | Elongation | % | 100 | 50 | 70 | 60 | 40 | 20 | 10 | 30 | 30 |
| | at break | | | | | | | | | | |
| | Relative | | 2.3 | 2.4 | 2.2 | 2.4 | 2.3 | 2.8 | 3.3 | 2.6 | 2.8 |
| | permittivity | | | | | | | | | | |
| | (10 GHz) | | | | | | | | | | |
| | Dielectric | | 0.0015 | 0.0018 | 0.0013 | 0.0018 | 0.0012 | 0.012 | 0.018 | 0.009 | 0.011 |
| | tangent | | | | | | | | | | |
| | (10 GHz) | | | | | | | | | | |
| | Adhesion | MPa | 15 | 25 | 20 | 25 | 13 | 15 | 5 | 18 | 17 |
| | force | | | | | | | | | | |

In the working examples 1 to 5, maleimide resin cured products with the fluororesin powder being uniformly dispersed therein, and having a sufficient strength were able to be produced.

In the comparative examples 1 to 4, the fluororesin powder was not uniformly dispersed due to a poor compatibility between the epoxy resin and the fluororesin powder, which resulted in a low strength, elongation at break and adhesion force of the cured product.

TABLE 2

| | | | Working | Working | Working | Working | Comparative | Comparative | Comparative |
|---|---|---|---|---|---|---|---|---|---|
| | | | example | example | example | example | example | example | example |
| | | | 6 | 7 | 8 | 9 | 5 | 6 | 7 |
| (a) | (a-6) | | 50 | 20 | 70 | 50 | | | |
| | (a-7) | | | | | | 60 | 70 | |
| | (a-8) | | | | | | | | 60 |
| (b) | (b-1) | | 49 | | | | 39 | 19 | |
| | (b-2) | | | | 19 | | | | |
| | (b-3) | | | 69 | | | | | 39 |
| | (b-4) | | | | | 49 | | | |
| (c) | (c-1) | | | | | | 1 | 1 | 1 |
| | (c-2) | | 1 | 1 | 1 | 1 | | | |
| (d) | (d-1) | | | | 10 | | | | |
| | (d-2) | | | 10 | | | | 10 | |
| | Cyclohexanone | | 60 | 70 | 30 | 50 | 40 | 60 | |
| Evaluation | Thixotropic | 1 rpm/ | 1.5 | 1.6 | 1.2 | 1.4 | 3.5 | 2.2 | 3.2 |
| result | ratio before | 10 rpm | | | | | | | |
| | film coating | | | | | | | | |
| | Film thickness | μm | 100 | 500 | 10 | 100 | Unmeasurable | 50 | Unmeasurable |
| | Relative | | 2.3 | 2.2 | 2.4 | 2.3 | 3.2 | 3.4 | 2.4 |
| | permittivity | | | | | | | | |
| | (10 GHz) | | | | | | | | |
| | Dielectric | | 0.0013 | 0.0012 | 0.0017 | 0.0014 | 0.013 | 0.015 | 0.0022 |
| | tangent | | | | | | | | |
| | (10 GHz) | | | | | | | | |
| | Arithmetic | μm | 0.5 | 0.7 | 0.2 | 0.4 | Unmeasurable | 3.2 | Unmeasurable |
| | average surface | | | | | | | | |
| | roughness (Ra) | | | | | | | | |

| | | | Comparative | Comparative | Comparative | Comparative | Comparative |
|---|---|---|---|---|---|---|---|
| | | | example | example | example | example | example |
| | | | 8 | 9 | 10 | 11 | 12 |
| (a) | (a-6) | | | | | | |
| | (a-7) | | | 50 | 70 | 20 | 50 |
| | (a-8) | | 70 | | | | |
| (b) | (b-1) | | | 49 | | | |
| | (b-2) | | | | 19 | | |
| | (b-3) | | 19 | | | 69 | |
| | (b-4) | | | | | | 49 |
| (c) | (c-1) | | 1 | 1 | 1 | 1 | 1 |
| | (c-2) | | | | | | |
| (d) | (d-1) | | | 10 | 10 | 10 | 10 |
| | (d-2) | | 10 | | | | |
| | Cyclohexanone | | | 60 | 70 | 50 | 60 |
| Evaluation | Thixotropic | 1 rpm/ | 2.2 | 2.3 | 2.5 | 2.3 | 2.4 |
| result | ratio before | 10 rpm | | | | | |
| | film coating | | | | | | |
| | Film thickness | μm | 30 | 100 | 10 | 500 | 100 |
| | Relative | | 2.5 | 2.8 | 3.3 | 2.6 | 2.8 |
| | permittivity | | | | | | |
| | (10 GHz) | | | | | | |
| | Dielectric | | 0.0023 | 0.011 | 0.019 | 0.009 | 0.011 |
| | tangent | | | | | | |
| | (10 GHz) | | | | | | |
| | Arithmetic | μm | 2.8 | 2.8 | 3.4 | 2.9 | 2.7 |
| | average surface | | | | | | |
| | roughness (Ra) | | | | | | |

In the working examples 6 to 9, since the fluororesin powder was uniformly dispersed, a low thixotropic ratio was exhibited, and there was also observed a low value of the arithmetic average surface roughness of the resin film after coating.

In the comparative example 5, a high thixotropic ratio was exhibited due to a poor compatibility between the maleimide compound (a-7) and the fluororesin powder; the composition failed to be turned into the shape of a film via coating.

In the comparative example 6, a relatively high thixotropic ratio was exhibited, and the composition was able to be turned into the shape of a film via coating. However, since the fluororesin powder was not uniformly dispersed, there was observed a high value of the arithmetic average surface roughness of the resin film after coating.

In the comparative example 7, a high thixotropic ratio was exhibited due to a poor compatibility between the cyclic olefin resin and the fluororesin powder; the composition failed to be turned into the shape of a film via coating.

In the comparative example 8, a relatively high thixotropic ratio was exhibited, and the composition was able to be turned into the shape of a film via coating. However, since the fluororesin powder was not uniformly dispersed, there was observed a high value of the arithmetic average surface roughness of the resin film after coating.

In the comparative examples 9 to 12, relatively high thixotropic ratios were exhibited, and each composition was able to be turned into the shape of a film via coating. However, since the fluororesin powder was not uniformly dispersed, there were observed high values of the arithmetic average surface roughness of the resin films after coating.

What is claimed is:

1. A maleimide resin composition comprising:
(a) a maleimide represented by the following formula (1): 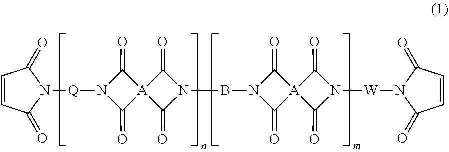
wherein A independently represents a tetravalent organic group having a cyclic structure(s); B independently represents an alkylene group that has not less than 6 carbon atoms, and may contain a hetero atom; Q independently represents an arylene group that has not less than 6 carbon atoms, and may contain a hetero atom; W represents a group represented by B or Q; n represents a number of 0 to 100, m represents a number of 0 to 100, provided that at least one of n or m is a positive number;
(b) a fluororesin powder; and
(c) a curing catalyst.

2. The maleimide resin composition according to claim 1, wherein the organic group represented by A in the formula (1) is any one of the tetravalent organic groups represented by the following structural formulae: 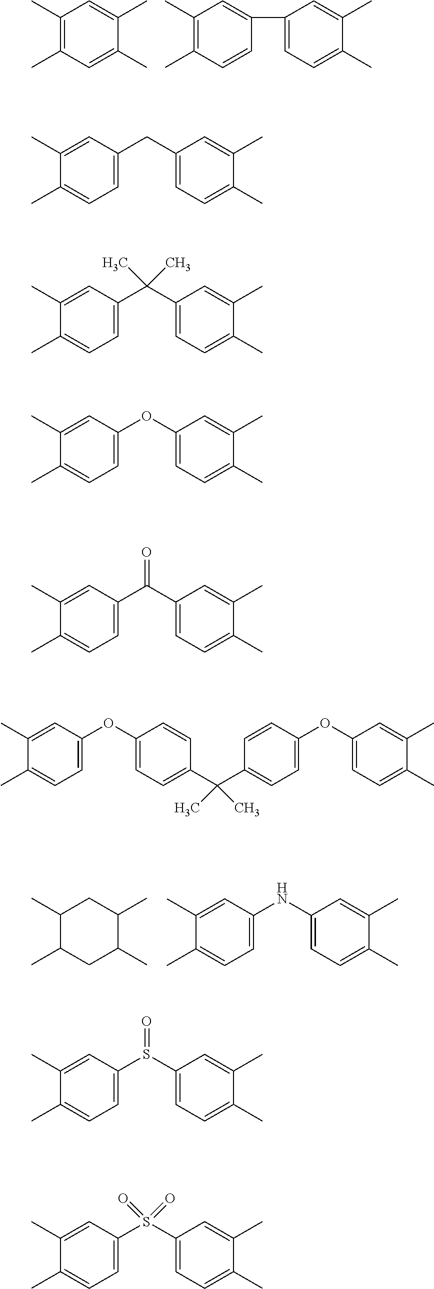
wherein bonds in the above structural formulae that are yet unbonded to substituent groups are to be bonded to carbonyl carbons forming cyclic imide structures in the formula (1).

3. The maleimide resin composition according to claim 1, wherein the fluororesin powder as the component (b) comprises at least one powder selected from polytetrafluoroethylene, polyvinylidene fluoride, polychlorotrifluoroethylene, tetrafluoroethylene-perfluoroalkyl vinyl ether copolymer, tetrafluoroethylene-hexafluoropropylene copolymer, polyvinyl fluoride, tetrafluoroethylene-hexafluoropropylene copolymer and ethyl ene-tetrafluoroethyl ene copolymer.

4. The maleimide resin composition according to claim 1 further comprising, as a component (d), a (meth)acrylate having not less than 10 carbon atoms.

5. A cured product of the maleimide resin composition according to claim 1.

6. A maleimide resin film comprised of the maleimide resin composition according to claim 1.
